(19) United States
(12) Patent Application Publication
(10) Pub. No.: US 2007/0138072 A1
(43) Pub. Date: Jun. 21, 2007

(54) Trash rack for nuclear power plant

(75) Inventor: Alan J. Bilannin, Princeton, NJ (US)

Correspondence Address: DAVID M QUINLAN, PC, 32 NASSAU STREET, SUITE 300, PRINCETON, NJ, 08542, US

(73) Assignee: Continuum Dynamics, Inc., Ewing, NJ (US)

(21) Appl. No.: 11/590,608

(22) Filed: Oct. 31, 2006

Related U.S. Application Data
(60) Provisional application No. 60/732,122, filed on Nov. 2, 2005.

(51) Int. Cl. B01D 29/00; B01D 33/00

(52) U.S. Cl. 210/153

(57) ABSTRACT

A trash rack for an emergency core cooling system of a nuclear power plant comprises at least one wire-mesh upright screen for filtering debris from coolant flowing in the cooling system. The upright screen is mounted in the coolant flow path with its bottom edge on the floor of an area forming part of the cooling system and a top edge is disposed above the floor at a height less than the level to which the coolant can be expected to rise during a loss of cooling accident. The trash rack also uniquely includes a wire-mesh roof screen that has a downstream edge mated with the top edge of the upright screen and extending upstream thereof to an upstream end spaced from the floor, thereby presenting an unobstructed opening between the floor and the upstream edge of the roof screen.

### CROSS-REFERENCE TO RELATED APPLICATIONS

This application claims the benefit of U.S. provisional application No. 60/732,122, filed Nov. 2, 2005, the contents of which are incorporated herein by reference.

### BACKGROUND OF THE INVENTION

1. Field of the Invention

The present invention relates to a trash rack for a water-cooled nuclear power plant, and more particularly, to a trash rack capable of intercepting significant amounts of debris in a reactor coolant flow while maintaining a sufficient coolant flow rate.

2. Description of Related Art

A nuclear power plant typically includes an emergency core cooling system (ECCS) that circulates large quantities of cooling water to critical reactor areas in the event of accidents. A boiling water reactor (BWR) commonly draws water from one or more reservoirs, known as suppression pools, in the event of a loss of coolant accident (LOCA). Water is pumped from the suppression pool to the reactor core and then circulated back to the suppression pool. A LOCA can involve failure of reactor components that introduce large quantities of solid matter into the cooling water, which entrains the solids and carries them back to the suppression pool. For example, if a LOCA results from the rupture of a high pressure pipe, quantities of thermal insulation, concrete, paint chips and other debris can be entrained in the cooling water. A pressurized water reactor (PWR) after a LOCA typically draws cooling water from a reactor water storage tank, and after sufficient water has been pumped into a containment area, recirculates this water through the reactor. A PWR has a containment area that is dry until it is flooded by the occurrence of an accident, and the ECCS employs a pump connected to a sump in the containment area to circulate the water through the reactor. The water that is pumped in the event of a PWR accident will also usually contain entrained solids that can include insulation, paint chips, and particulates. In other words, in both types of reactor, cooling water is drawn from a reservoir and pumped to the reactor core, and entrained solids can impair cooling and damage the ECCS pumps if permitted to circulate with the water.

As a result, strainers are typically placed in the coolant flow path upstream of the pumps. These strainers are designed to filter solids from the coolant without unduly retarding the coolant flow, that is, maintaining the pressure (head) loss across the strainer at a minimum. Strainers are commonly mounted to pipes that are part of the ECCS and that extend into the suppression pool (BWR) or sump (PWR), and the ECCS pumps draw water through the strainers and introduce it to the reactor core. There has been considerable effort expended on strainer design to decrease head loss across the strainer for the intended coolant flow. Examples of particularly effective strainers are shown in U.S. Pat. No. 5,759,399 and Intl. Publ. No. WO2005/113108, both of which are assigned to the same assignee as the present invention. The descriptions therein of nuclear reactor strainers and their operation and installation are incorporated herein by reference as if set forth in full.

The efficacy of these strainers in filtering debris from the coolant without unduly obstructing coolant flow is directly proportional to the surface area they present to the flow. However, increasing strainer surface area makes the strainer larger, and thus more expensive and more difficult to work with. Moreover, if strainers are subjected to too much debris, they will begin to clog even if they are very large. Accordingly, nuclear power plants sometimes include separate trash racks in the coolant flow path upstream of the strainers to filter out coarser debris and fibrous material before it reaches the strainers. This enables the strainers themselves to be made smaller.

FIG. 1 schematically illustrates a typical prior art trash rack used in a nuclear power plant. The trash rack TR is shown in cross section installed in a nuclear reactor containment area CA, such as that shown in FIG. 7 of Intl. Publ. No. WO2005/113108. A strainer ST, which can be like those described in U.S. Pat. No. 5,759,399 and WO 2005/113108, is disposed on an outlet pipe OP that extends through the floor FC of the containment area and leads to an ECCS pump (not shown). Coolant water CW in the containment area flows generally in the direction of the arrows FA from the containment area CA and into the outlet pipe OP through the strainer ST. A trash rack TR, which is typically a sheet of heavy wire mesh, is placed upright in the containment area in the path of the coolant flow to the outlet pipe OP. The trash rack TR traps coarse debris and fibrous material FD before they can reach the strainer ST. In the PWR shown in FIG. 7 of WO 2005/113108, trash racks can be conveniently placed in the openings in the shield wall 102. The exact placement and manner of installation of the trash rack depends on the configuration of the reactor in which it is installed. See, for example, the BWR shown in EP 1,653,479. Obviously, it must be mounted in a manner that requires all coolant flow to pass through a trash rack before reaching a strainer.

At the onset of a LOCA, before the trash rack has trapped any debris, the coolant water is at a level L1, shown as a dot-dash phantom line in FIG. 1, which provides sufficient pressure head at the entrance to the outlet pipe for proper operation of the ECCS pump. The trash rack TR is typically designed to reach vertically to the level L1, in order to capture debris floating on the surface of the coolant water. However, as the trash rack TR traps more and more debris, the water cannot flow as easily through the wire mesh, and eventually the trash rack can become completely clogged and very little, if any, coolant water passes through it. Then, as the ECCS pumps recirculate the coolant water, the water behind the trash rack eventually rises to a level L2 high enough to flow over the trash rack, while the water level L3 downstream of the trash rack falls correspondingly. If the water level L3 falls too low, it can reduce the pressure head at the entrance to the outlet pipe and interfere with pump operation.

This type of trash rack can only trap a relatively modest amount of debris before the downstream water level L3 is reduced to a dangerously low level at which the ECCS pumps become inefficient, are damaged, or even fail. The problem, therefore, is how to trap or intercept large quantities of debris without significantly impacting the flow of coolant water to the ECCS pumps. In particular, there is a need to trap sufficient quantities of debris while avoiding excessive lowering of the water level leading to the pumps.

### SUMMARY OF THE INVENTION

It is an object of the present invention to provide an improved trash rack that can trap more debris than prior art trash racks while maintaining a safe pressure head for the ECCS pumps.

In accordance with a first aspect of the invention, a trash rack for an emergency core cooling system of a nuclear power plant comprises (i) at least one porous upright member for filtering debris from coolant flowing in the cooling system, the trash rack being mountable in the power plant with the upright member disposed in a path of the coolant flow so that a bottom of the upright member mates with a floor of an area forming part of the cooling system and a top of the upright member is disposed above the floor, and (ii) a porous roof member for filtering debris from the coolant, the roof member mating with the top of the upright member and extending upstream thereof to an upstream end spaced from the floor for providing an opening bounded by the floor and the upstream end when the trash rack is mounted in the power plant.

In another preferred embodiment, each of the porous members comprises a wire mesh screen. In addition, each of the members may be generally planar, and a downstream edge of the roof panel can mate with the top edge of the upright panel.

In accordance with another aspect of the invention, the trash rack may further comprise at least a second upright panel upstream of the first upright panel and having a bottom edge mating with the floor and a top edge mating with the roof panel, wherein the upright panels are wire mesh screens with the upstream second upright panel having a coarser mesh than the first upright panel. The trash rack can include more upright wire mesh screens upstream of the second screen, each having a coarser mesh than the next adjacent downstream upright screen. The upright panels can be generally perpendicular to the roof panel and mounted generally perpendicular to the floor, or the upright panels can be constructed so that the upstream edge of the roof panel is farther from the floor than the downstream edge. In yet another variation, the upright panels are generally parallel to each other and form a non-right angle α with the floor downstream of the panels with the upright panels forming an angle β with the roof panel whereby the upstream edge of the roof panel is farther from the floor than the downstream edge.

In accordance with still another aspect of the invention, a nuclear power plant includes a trash rack system for a power plant emergency core cooling system for a nuclear power plant, the trash rack system comprising:
a first trash rack including (i) at least one generally planar, upright wire-mesh screen for filtering debris from coolant flowing in the cooling system, wherein the upright screen is disposed in a path of the coolant flow and has a bottom edge mating with a floor of an area forming part of the cooling system and a top edge disposed above the floor, and (ii) a generally planar, wire-mesh roof screen for filtering debris from the coolant, wherein a downstream edge of the roof screen mates with the top edge of the upright screen and the roof screen extends upstream of the upright screen to an upstream edge spaced from the floor to provide an opening bounded by the floor and the upstream edge of the roof screen; and
at least a second trash rack including (i) at least one generally planar, upright wire-mesh screen for filtering debris from coolant flowing in the cooling system, wherein the upright screen is disposed in a path of the coolant flow and has a bottom edge mating with the floor and a top edge disposed above the floor, and (ii) a generally planar, wire-mesh roof screen for filtering debris from the coolant, wherein a downstream edge of the roof screen mates with the top edge of the upright screen and the roof screen extends upstream of the upright screen to an upstream edge spaced from the floor to provide an opening bounded by the floor and the upstream edge of the roof screen, the opening being downstream of the first trash rack.

In a variation on that aspect of the invention, a nuclear power plant includes a trash rack system with a first trash rack as described in the preceding paragraph and a second trash rack downstream of the first trash rack including (i) at least one generally planar, upright wire-mesh screen for filtering debris from coolant flowing in the cooling system, wherein the upright screen is disposed in a path of the coolant flow and has a bottom edge spaced from a floor of an area forming part of the cooling system and a top edge disposed at a level above the floor to which the coolant can be expected to rise, and (ii) a generally planar, wire-mesh floor screen for filtering debris from the coolant, wherein a downstream edge of the floor screen mates with the bottom edge of the upright screen and the floor screen extends upstream of the upright screen to an upstream edge spaced from the floor.

### BRIEF DESCRIPTION OF THE DRAWINGS

The objects of the invention will be better understood from the detailed description of its preferred embodiments which follows below, when taken in conjunction with the accompanying drawings, in which like numerals and letters refer to like features throughout. The following is a brief identification of the drawing figures used in the accompanying detailed description.

FIG. 1 is a schematic side view of a prior art trash rack installed in a containment area of a nuclear reactor.

FIG. 2 is a schematic side view of a trash rack in accordance with a first embodiment of the invention.

FIG. 3 is a schematic side view of a trash rack in accordance with a second embodiment of the invention.

FIG. 4 is a schematic side view of a trash rack in accordance with a third embodiment of the invention.

FIG. 5 is a schematic side view of a trash rack in accordance with a fourth embodiment of the invention.

FIG. 6 is a schematic side view of a trash rack system in accordance with a fifth embodiment of the invention.

FIG. 7 is a schematic side view of a trash rack system in accordance with a sixth embodiment of the invention.

One skilled in the art will readily understand that the drawings are not strictly to scale, but nevertheless will find them sufficient, when taken with the detailed descriptions of preferred embodiments that follow, to make and use the present invention.

### DETAILED DESCRIPTION OF PREFERRED EMBODIMENTS

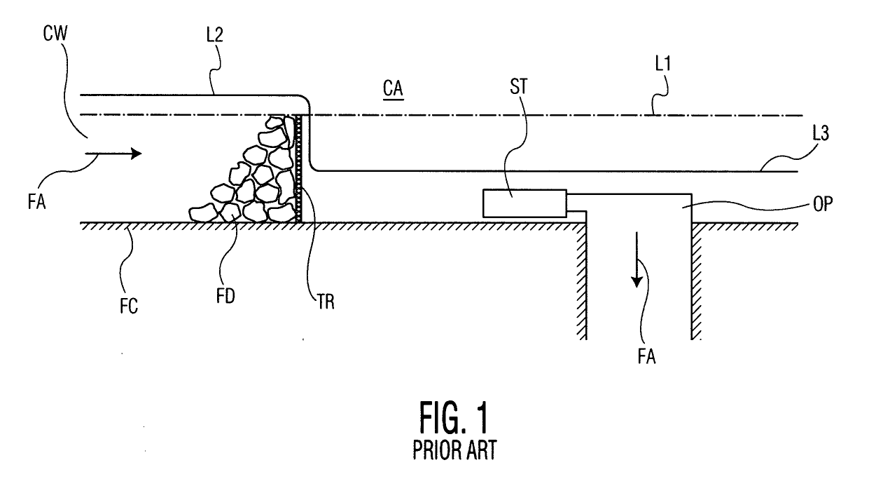

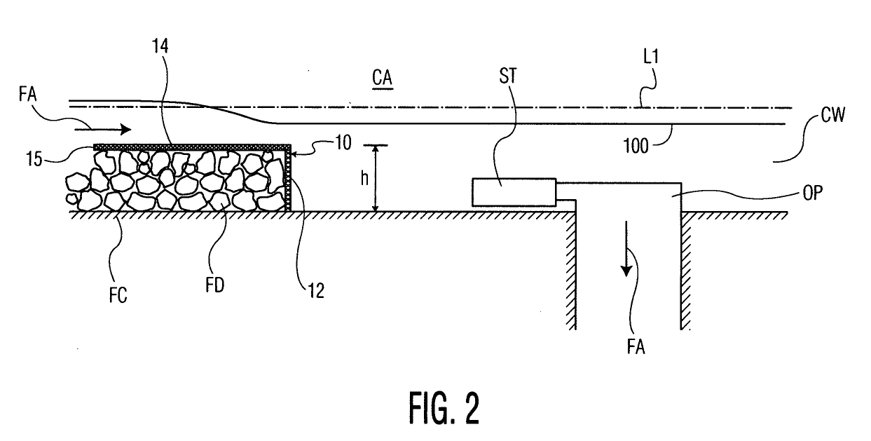

FIG. 2 schematically illustrates a trash rack 10 in accordance with a basic embodiment of the present invention installed in a reactor containment area CA in a fashion similar to that shown in FIG. 1, namely so that coolant flow FA passes through the trash rack 10 before it reaches the strainer ST and the outlet pipe OP. The trash rack 10 includes a generally upright panel member 12 that in this embodiment is a heavy wire-mesh sheet (woven in a manner similar to a window screen) that is strong enough to withstand the hydrodynamic forces exerted by the coolant flow when the member 12 becomes partially or wholly blocked by the debris FD. The panel member 12 is generally planar and is secured in place perpendicular to the floor FC with its bottom edge in mating contact with the floor.

In addition, the trash rack 10 includes a generally planar roof panel member 14 that in the present embodiment is also a wire-mesh sheet. The downstream edge of the roof member 14 is disposed proximate to the top edge of the upright member 12, and is preferably attached to the top edge thereof perpendicular to the planar upright member by welding or other suitable means. (It will be appreciated that the upright member 12 need not intersect with the roof member 14 at the downstream edge of the roof member.) The roof member 14 extends upstream from the upright member 12 relative to the coolant flow (that is, in the direction opposite the arrow FA near the roof member in FIG. 2). The roof panel is thus generally parallel to the floor FC of the containment area, and the upstream edge 15 of the roof panel is spaced from the floor FC to provide an unobstructed opening between the floor FC and the upstream edge 15. The roof panel member 14 can be supported by brackets or other suitable means to keep it in position.

As described above, the level of the coolant water CW at the onset of a LOCA, before the trash rack 10 has trapped any debris, is depicted by the phantom line L1. This level is typically a known design parameter of any particular reactor, and is specified to provide coolant water at a sufficient pressure head to the ECCS pumps. The upright member 12 of the trash rack 10 extends to a height h from the floor FC that is less than the height of level L1. In a preferred installation, h is no more than 80% of the level L1, but those skilled in the art will be readily able to determine an optimum height h for a given installation depending on the reactor design specifications.

In operation, the roof member 14 permits the trash rack 10 to accumulate more debris than a conventional prior art trash rack like the one shown in FIG. 1, because the roof member 14 traps debris FD behind the upright member and prevents it from flowing over the trash rack and into the strainer. An advantage of the trash rack 10 is that it can effectively trap more debris than the conventional trash rack, even though it does not extend all the way to the level L1. It is also especially effective for trapping floating fibrous debris, which can flow over the prior art trash rack TR shown in FIG. 1 and clog the strainer ST. At the same time, the lower height of the upright member 12 maintains a sufficient coolant level 100, higher than the level L3 in FIG. 1, at the entrance to the strainer ST, thus ensuring sufficient pressure head at the ECCS pumps.

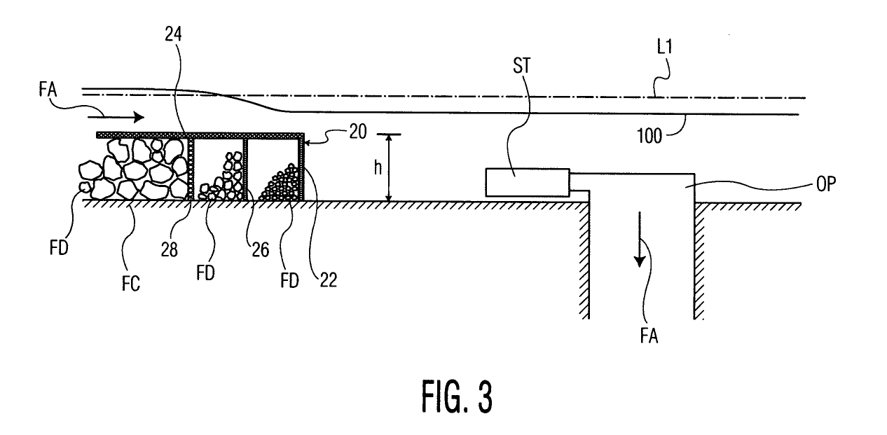

FIG. 3 schematically illustrates a second embodiment of the invention. This embodiment is similar to the embodiment shown in FIG. 2. (FIG. 3 uses “20” series numbers to denote components that generally correspond to components designated by like “10” series numbers in FIG. 2.) The trash rack 20 according to this second embodiment has a first upright panel member 22 and a roof panel member 24 in generally the same relation as the upright member 12 and roof member 14 in the first embodiment. However, the trash rack 20 also includes additional upright members under the roof member 24 behind (upstream of) the first member 22. In the depicted embodiment there is a second generally upright member 26 and a third generally upright member 28, both of which extend from the floor FC to the roof member 24. The third upright panel member comprises a relatively coarse wire mesh that traps very large debris, with the second upright member 26 having smaller mesh openings than the third member 28 to trap finer debris, and the first upright member 22 having mesh openings that are smaller than the second upright member 26 to trap still finer debris. This arrangement enables the trash rack to trap even more debris than the embodiment depicted in FIG. 2.

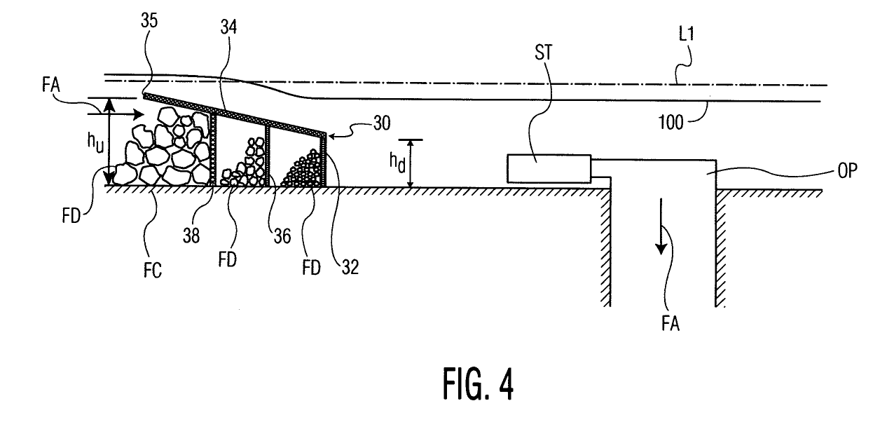

FIG. 4 schematically illustrates a third embodiment of the invention. (FIG. 4 uses “30” series numbers to denote components that generally correspond to components designated by like “20” series numbers in FIG. 3.) The trash rack 30 of this embodiment is similar to the embodiment shown in FIG. 3, with an upright panel member 32, a roof panel member 34 and two additional upright panel members 36 and 38. In this embodiment the first upright member 32 has a height h_{d}, while the upstream edge 35 of the roof member 34 is spaced from the floor FC at a height hᵤ that is higher than h_{d}. With this construction, the flow over the top of the trash rack slows as it reaches the downstream end of the roof member, thus promoting settling out of the flow of any entrained debris that might flow over the trash rack or through the porous panels before it reaches the strainer ST. This can be especially advantageous in reactors the construction of which permits the trash racks to be spaced well upstream in the coolant flow from the strainers.

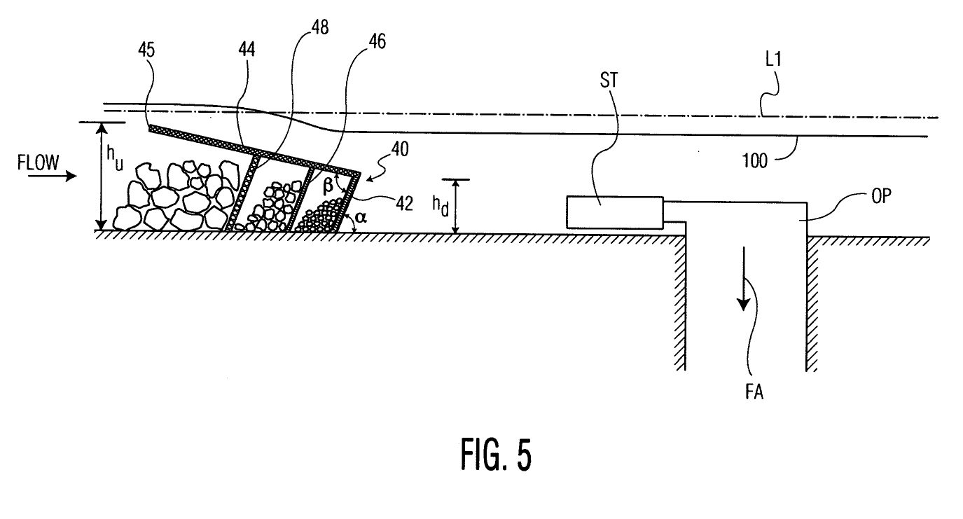

FIG. 5 schematically illustrates a fourth embodiment of the invention. This embodiment is a variation on the third embodiment, with FIG. 5 using “40” series numbers to denote components that generally correspond to components designated by like “30” series numbers in FIG. 4. The trash rack 40 according to this fourth embodiment has a first upright member 42 that forms a non-right angle α with the floor FC of the containment area downstream of the trash rack. That is, in the previous embodiments, α was about 90°, but a preferred range for α is 45° to 135°, with the most preferred non-right angle value being about 45°. A roof member 44 forms an angle β, generally about 90°, with the first upright member 42, although β can vary between 45° to 135° depending on the value of α. As in the FIG. 4 embodiment, the downstream edge of the roof member 44 is attached to the top of the upright member 42, and the roof member 44 is slanted in the direction of flow FA from a height hᵤ at its upstream end to a lower height h_{d} at its downstream end. The additional upright members 46 and 48 are parallel to the upright member 42, and the upright members 48, 46 and 42 have decreasing mesh size screens, as in the embodiments in FIGS. 3 and 4. As in the embodiment in FIG. 4, the decrease in height of the trash rack 40, from hᵤ to h_{d}, lowers the velocity of the flow FA downstream of the trash rack and encourages any debris remaining in the coolant water to settle out onto the floor FC of the containment area before reaching the strainer ST. In addition, slanting the upright member at an angle α enables the members 42, 44, 46 and 48 to have a greater surface area for the same upstream height hᵤ. It also presents to the flow a trash rack that can act as a kind of “scoop” to trap more debris. In addition, slanting the two members can optimize the efficiency for different types of debris with different settling and transport characteristics. For example, material that is less likely to be carried downstream of the trash rack may be trapped better using a geometry in which the roof member 44 is at an angle that diverges with the floor FC in an upstream direction, as in FIGS. 4 and 5. Conversely, a trash rack with a roof member converging with the floor in the upstream direction would trap lighter materials better, since they would have a higher propensity to travel over obstructions like the trash rack.

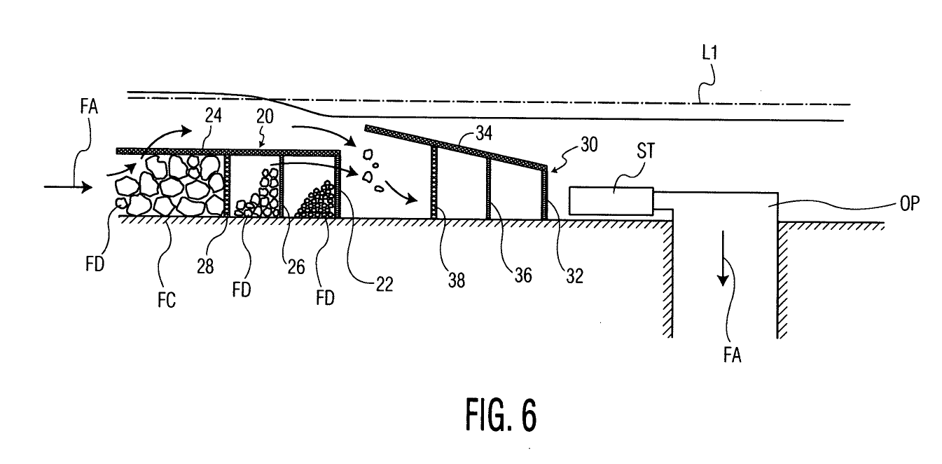

FIG. 6 schematically illustrates a fifth embodiment of the invention representing an advantageous installment of two trash racks in “series” in the coolant flow, with a separate downstream trash rack to filter debris that may escape an upstream trash rack. In FIG. 5, the upstream trash rack 20 is in accordance with the second embodiment (FIG. 3) and the downstream trash rack 30 is in accordance with the third embodiment (FIG. 4). However, those skilled in the art will appreciate that any embodiments of the invention can be arranged in series in accordance with the principles employed in a multi-rack installation in accordance with this embodiment. In the embodiment depicted in FIG. 6, the downstream trash rack 30 has a slanted top that will more readily scoop floating debris that flows over the upstream rack 20, in addition to reducing the downstream flow velocity, as discussed above. Those skilled in the art will recognize that this order could be reversed, so that any debris flowing over the trash rack 30 will be more likely to settle toward the floor FC of the containment area to be trapped by a downstream trash rack. Nor is the invention limited to using just two trash racks in series relation, and any number can be used consistent with reactor specifications.

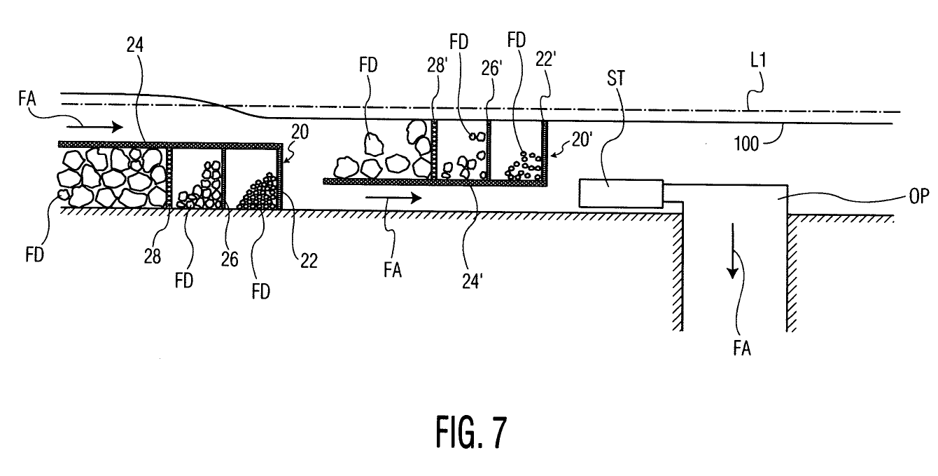

FIG. 7 schematically illustrates another manner of using two trash racks to maximize the amount of debris that is captured before the flow reaches the strainer ST. This embodiment includes an upstream trash rack in accordance with any of the preceding embodiments (or variations thereof). In FIG. 7, the upstream trash rack 20 is in accordance with the FIG. 3 embodiment. A downstream inverted trash rack 20′ includes an upright panel member 22′, the top edge of which is at the coolant water level 100. A floor panel member 24′ is spaced from the floor FC of the containment area and has its downstream edge attached to the bottom of the upright member 22′. Additional upright panel members 26′ and 28′ extend upwardly from the floor member 24′ to the level 100. It will be appreciated that the downstream trash rack 20′ can be identical to the trash rack 20, except that it is inverted. The downstream trash rack 20′ is very effective in trapping floating debris and debris that has not settled to the floor FC of the containment area. It will be immediately appreciated that one or more inverted trash racks can be placed downstream of one or more trash racks of similar or different construction (such as the combination described in connection with FIG. 6). As with the preceding embodiments, the panel members are preferably wire-mesh screens.

It will be understood that the upright and roof panel members need not be made of woven wire mesh. They can be provided by any porous construction that permits fluid to flow through the panel while filtering debris borne by the fluid. For example, alternate constructions can include a perforated sheet, an expanded wire mesh, or a series of closely spaced parallel rods, to name just a few. In addition, the panels can be mounted to each other and in a reactor in any manner that is consistent with the purpose of the invention, which is to filter debris from reactor coolant flow. That is, they should be mounted in a manner that directs the coolant flow through a trash rack before it reaches a strainer. The provision of suitable mounting structures will also be well within the level of skill of those familiar with nuclear power plant construction and structures used to mount prior art trash racks.

Those skilled in the art will readily recognize that only selected preferred embodiments of the invention have been depicted and described, and it will be understood that various changes and modifications can be made other than those specifically mentioned above without departing from the spirit and scope of the invention, which is defined solely by the claims that follow.

What is claimed is:

1. A trash rack for an emergency core cooling system of a nuclear power plant, the trash rack comprising:
at least one porous upright member for filtering debris from coolant flowing in the cooling system, said trash rack being mountable in the power plant with said upright member disposed in a path of the coolant flow so that a bottom of said upright member mates with a floor of an area forming part of the cooling system and a top of said upright member is disposed above the floor; and
a porous roof member for filtering debris from the coolant, said roof member mating with said top of said upright member and extending upstream thereof to an upstream end spaced from the floor for providing an opening bounded by the floor and said upstream end when said trash rack is mounted in the power plant.

2. A trash rack as in claim 1, wherein each of said members comprises a wire mesh screen.

3. A trash rack as in claim 1, wherein each of said members is a generally planar panel, and a downstream edge of said roof panel mates with a top edge of said upright panel.

4. A trash rack as in claim 3, further comprising at least a second said upright panel upstream of said first upright panel and having a bottom edge mating with the floor and a top edge mating with said roof panel, wherein said first upright panel comprises a wire mesh screen and said second upright panel comprises a wire mesh screen coarser than said wire mesh screen of said first upright panel.

5. A trash rack as in claim 4, further comprising at least a third said upright panel upstream of said second upright panel and having a bottom edge mating with the floor and a top edge mating with said roof panel, wherein third upright panel comprises a wire mesh screen coarser than said wire mesh screen of said second upright panel.

6. A trash rack as in claim 5, wherein said upright panels are generally perpendicular to said roof panel.

7. A trash rack as in claim 5, wherein said upright panels are mountable generally perpendicular to the floor and constructed so that said upstream edge of said roof panel is farther from the floor than said downstream edge when said trash rack is mounted in the power plant.

8. A trash rack as in claim 5, wherein said upright panels are generally parallel to each other and form an angle α with the floor downstream of said panels when said trash rack is mounted in the power plant, said upright panels forming an angle β with said roof panel whereby said upstream edge of said roof panel is farther from the floor than said downstream edge when said trash rack is mounted in the power plant.

9. A trash rack as in claim 5, wherein α is a non-right angle between about 45° and 135°, and β is between about 45° and 135°.

10. A trash rack as in claim 9, wherein α is an acute angle and β is about 90°.

11. A nuclear power plant including a trash rack system for a power plant emergency core cooling system for a nuclear power plant, the trash rack system comprising:
a first trash rack including (i) at least one generally planar, upright wire-mesh screen for filtering debris from coolant flowing in the cooling system, wherein said upright screen is disposed in a path of the coolant flow and has a bottom edge mating with a floor of an area forming part of the cooling system and a top edge disposed above the floor, and (ii) a generally planar, wire-mesh roof screen for filtering debris from the coolant, wherein a downstream edge of said roof screen mates with said top edge of said upright screen and said roof screen extends upstream of said upright screen to an upstream edge spaced from the floor to provide an opening bounded by the floor and said upstream edge of said roof screen; and
at least a second trash rack including (i) at least one generally planar, upright wire-mesh screen for filtering debris from coolant flowing in the cooling system, wherein said upright screen is disposed in a path of the coolant flow and has a bottom edge mating with a floor of an area forming part of the cooling system and a top edge disposed above the floor, and (ii) a generally planar, wire-mesh roof screen for filtering debris from the coolant, wherein a downstream edge of said roof screen mates with said top edge of said upright screen and said roof screen extends upstream of said upright screen to an upstream edge spaced from the floor to provide an opening bounded by the floor and said upstream edge of said roof screen, said opening being downstream of said first trash rack.

12. A nuclear power plant as in claim 11, wherein at least one said trash rack further includes at least a second said upright screen upstream of said first upright screen and having a bottom edge mating with the floor and a top edge mating with said roof panel, wherein said second upright screen comprises a wire mesh coarser than a wire mesh said first upright screen.

13. A nuclear power plant as in claim 12, wherein said upright screens of at least one said trash rack are generally perpendicular to said roof screen thereof and mounted generally perpendicular to the floor.

14. A nuclear power plant as in claim 12, wherein said upright screens of at least one said trash rack are generally perpendicular to the floor and said upstream edge of said roof screen is farther from the floor than said downstream edge.

15. A nuclear power plant as in claim 12, wherein said upright screens are generally parallel to each other and form an acute angle α with the floor downstream of said panels, and said upstream edge of said roof screen is farther from the floor than said downstream edge.

15. A nuclear power plant including a trash rack system for a power plant emergency core cooling system for a nuclear power plant, the trash rack system comprising:
a first trash rack including (i) at least one generally planar, upright wire-mesh screen for filtering debris from coolant flowing in the cooling system, wherein said upright screen is disposed in a path of the coolant flow and has a bottom edge mating with a floor of an area forming part of the cooling system and a top edge disposed above the floor, and (ii) a generally planar, wire-mesh roof screen for filtering debris from the coolant, wherein a downstream edge of said roof screen mates with said top edge of said upright screen and said roof screen extends upstream of said upright screen to an upstream edge spaced from the floor to provide an opening bounded by the floor and said upstream edge of said roof screen; and
a second trash rack downstream of said first trash rack and including (i) at least one generally planar, upright wire-mesh screen for filtering debris from coolant flowing in the cooling system, wherein said upright screen is disposed in a path of the coolant flow and has a bottom edge spaced from the floor and a top edge disposed at a level above the floor to which the coolant can be expected to rise, and (ii) a generally planar, wire-mesh floor screen for filtering debris from the coolant, wherein a downstream edge of said floor screen mates with said bottom edge of said upright screen and said floor screen extends upstream of said upright screen to an upstream edge spaced from the floor.
